(19) United States
(12) Patent Application Publication
(10) Pub. No.: US 2012/0167446 A1
(43) Pub. Date: Jul. 5, 2012

(54) Artificial bait for amateur fishing

(76) Inventor: Sergiy Vladlenovich UL'YANOV, Dnipropetrovs'k (UA)

(21) Appl. No.: 13/230,336

(22) Filed: Sep. 12, 2011

(30) Foreign Application Priority Data
Oct. 28, 2010 (UA) UA 2010 12800

(51) Int. Cl. A01K 85/14

(52) U.S. Cl. 43/42.03

(57) ABSTRACT

The invention concerns artificial baits of wobbler's type.

The artificial bait comprises a body having its centre of gravity located at its front portion with at least one hole for fixing a fishing line and with at least one hole for fixing at least one hook, with a plate having the lateral parts symmetrically curved convex relative to its longitudinal axis of symmetry and movably attached to the nose portion or to the lower portion of the body with fixed arrangement of its longitudinal axis at angle more 0° but less 180° to the body longitudinal axis by means of a motionless holder with a possibility of the plate rotation round the axis. The body is made of a material having density more than density of water.

The bait has effective oscillations in a considerable range of frequencies and amplitudes.

### FIELD OF THE INVENTION

The invention concerns amateur fishing, in particular artificial baits of wobbler type, and can he used for amateur catching predatory fish by a pulling up method (spin fishing technique with throwing or trolling, as well as long line fishing).

### BACKGROUND OF THE INVENTION

One of the effective methods of spinning predatory fish is to provide for uniform leading bait, in particular at immediate proximity to a bottom, thus the bait should move along the bottom without rising up to the top water layers. In the course of bottom fishing, especially at considerable depths and counter flows, there is occurred a problem, which consists in availability of buoyancy resulting from resistance of a fishing line and a bait itself to water flow.

On such a condition, at uniform leading, the bait moves non-horizontally, but forward and upwards, keeping away from the bottom. Therefore after the beginning of the movement, the bait occurs at a considerable distance from the bottom and, accordingly, from the places of probable availability of a predator, and hereby the efficiency of the process sharply worsens. To decrease the buoyancy negative effect, there are used heavy baits with small head resistances at simultaneous reducing diameter of a fishing line. Such a solution of the problem provides for flatter movement of the bait in the water, however it does not resolve the problem as a whole. Besides, the application of the coarsened baits makes a predator cautious, and the use of the thinner fishing lines raises the risk of their break.

Practically, the single bait, which can uniformly move irrespective of the buoyancy at the specified depth, is a bait of wobbler type that often represents plastic or wooden bait with a plate beveled downwards and placed at the bait front bottom portion, this plate being angled to the longitudinal axis of the bait. Such a plate operates as an antiwing and provides deepening the wobbler for structurally specified depth and its uniform movement at this depth. Besides, while turning in a counter water stream in one or other direction, the plate provides uniform and active oscillations for the wobbler body motionlessly connected to the same. Thus, in the course of the wobbler movement, the plate appears angled to running water stream whereby this water stream creates the force directed downwards.

After throwing, the wobbler, which floats in a motionless state, moves forward and downwards, gradually deepening itself for structurally specified depth. At the moment when the buoyancy is equilibrated with the force deepening the wobbler, it starts uniform moving at corresponding structurally set horizon of leading.

The wobbler for deep fishing is equipped with a long vane located at the acute angle to the wobbler axis. Sometimes the vane and the wobbler axis coincide. At leading, such wobblers have considerable resistance, and blades, like a car antiwings, make them deepen for the big depth [Brothers Scherbakovs. Modern Spinning Technique.—M.-OOO Publishing house Astrel. 2003, p. 122-123].

The wobbler oscillations created by variable forces, which are applied to the nose part of the wobbler body in a horizontal plane, are very attractive to a predator as they perfectly imitate movement of a small living fish.

Except floating models of wobblers, which deepen exclusively at the expense of the plate operation, there are also wobbler models sinking at motionless state. However the lateral forces transmitted by the plate onto the wobbler body and resulted in its alternate oscillations in one or another direction are insufficient to insure active oscillations of the heavy body. Ratio of sinking wobbler mass to its volume is rather small and therefore the wobbler slowly enough lowers onto the bottom, and in the case of water current, the wobhler is brought aside from the place of throwing. Thus, in the course of fishing at considerable depth, even sinking wobblers are deepened by leading.

As for the wobbler occurrence at the operating depth, there is need in its movement, using even sinking wobblers for spin fishing technique with throwing at big depth is considered ineffective, because an essential part of the path from the throw place to the fisher is covered by the gradually plunging wobbler not at the bottom, but in the higher layers of water where the probability of a predator existence is insignificant.

A wobbler is rather light and sailing bait, which cannot be thrown especially far. Before deepening, the wobbler has already passed some portion of its path. It is especially evident while fishing with the use of the wobblers, which are deepened at the considerable depth, as they frequently reach a bottom at the very bank of the river or others. Even the special deepening models of the wobblers are failure to sink to the lowest depth. The real horizon of wobblers leading is rather restricted. More often the floating wobblers, suspending and sinking wobblers hardly reach 3 m at spin fishing technique with throwing [Brothers Scherbakovs. Fishing Pike—M.-OOO Publishing house Astrel, 2003. p. 115-117].

The closest bait as for its technical essence to the filed invention is the artificial bait for amateur fishing of a wobbler type comprising a body configured in the form of a small fish made of material having density less than water one, with loops for hooks and a fishing line. The bait contains the metal plate inserted into the nose portion of the body and bent at 45° angle to the horizontal plane of the body, hich centre of gravity is located at its head portion [RU No. 2056750 C1. A01K 85/14. 1996].

In water, under a static condition, the specified bait is situated at a vertical position and deepens only for ⅔ of its length with its tail part being under water. At the beginning of pulling up procedure, the bait deepens and occupies the horizontal position with simultaneous playing to imitate a small living fish. The artificial bait is equipped with the motionless nose plate providing active oscillations relative to the light plastic or wooden body, however it cannot ensure any active oscillations for heavy, in particular, and metal body at uniform leading. The bait is not intended for deep fishing.

Such features of the artificial bait as its small weight and availability of large plate aggravate its flight performances. At throwing, it cannot fly for a long distance, including such a failure as almost regular overflowing fishing line with hooks. On stopping, the bait interrupts its oscillation, reducing attraction for a predator. To be deepened at the operating depth, the bait should move. As a result, only a portion of the path operates at the necessary depth, and this fact makes this type of bait ineffective while being used for deep spin fishing technique with throwing.

The artificial bait has wide oscillations of relatively small frequency. Changing the character of its playing would take place only owing to changing the main design elements. substantially, creating a new bait with the use of new industrial equipment.

The motionless arranging the plate angled to the bait longitudinal axis results in creation of wide oscillations of low frequency. In some cases, the predator prefers baits with high-frequency oscillations. Such oscillations could be created by the baits of other types.

The bait oscillations are only possible at leading. But at stopping, the bait is smoothly floating, slowly sinking, or hanging up in the thickness of water. In this connection, the bait is not suitable for fishing by an effective bottom method of jig, wherein the bait moves step by step and should actively fluctuate not only at lifting phase, but also at lowering onto the bottom, and more often the attacks of a predator occur at lowering phase.

Since the bait cannot have its own considerable weight, and its deepening occurs as a result of complex hydrodynamic processes, such artificial baits are manufactured of plastic material or special wood with assembly process of high accuracy. They are manufactured using the high-quality and expensive process equipment. High requirements are also made to the quality of plastics and wood, which the baits manufactured of, since in the course of operation, they have considerable loadings produced, particularly because of water obstacles. and are also damaged by predators with sharp teeth. Therefore the specified bait of a wobbler type is considered as one of the most expensive one among existing baits. Besides, there are specially designed constructions of wobblers intended for application at considerable depths while using trolling or long line fishing techniques that consist in drawing baits behind a moving boat. As a rule, a wobbler of such a construction has an elongated vane and rather considerable sizes of a body being necessary for their proper use at considerable depths. Thus, the operating depth of deepening the wobbler is relatively constant and slightly increases with increasing speed of the wobbler that in some cases negatively affects its efficiency. In addition, in the course of trolling fishing technique with the use of wobbler, it is problematic to essentially change a depth of a wobbler leading, especially to increase its deepening relatively structurally set depth of immersing the wobbler model used. While applying a wobbler for bottom fishing by trolling technique, there is need in setting the models, which pass in the process of leading over the upper crests of bottom topography, therefore in the course of movement, the wobbler passes highly enough over the bottom hollows, wherein the places of a predator existence are most probable, accordingly, in these cases the probability of a bottom predator attack decreases.

### OBJECTS OF THE INVENTION

The object of the present invention is, by changing the known designs, to create a bait for amateur fishing which at minimum speed of leading would create effective oscillations within a considerable range of frequencies and amplitudes, would be universal for application at different kinds of fishing techniques, in particular, a spin fishing technique with throwing and trolling, including deep fishing at the big depths, as a result, the achievement of the above said object would raise the productivity of catching predatory fish, and it would have a low cost due to the possibility of using inexpensive materials, universal set of component parts, manufacturing with the use of standard equipment without application of expensive technologies.

The object is achieved with an artificial bait of wobbler type for amateur fishing, which comprises a body having its centre of gravity located at its forward portion with at least one hole for fixing a fishing line and with at least one hole for fixing at least one hook, with a plate attached to the body at an angle to the same, wherein, according to the invention, the holes for fixing the fishing line are performed at the upper portion of the body over the spoon-bait center of gravity or with displacement to the nose portion of the body, the plate having the lateral parts symmetrically curved convex relative to its longitudinal axis of symmetry is movably attached, by means of a motionless holder, to the nose portion or to the lower portion of the body with fixed arrangement of its longitudinal axis at angle more 0° but less 90° to the body longitudinal axis, with possibility of the plate rotation round the axis passing through the points of the plate attachment to the holder, parallel to the longitudinal axis of the plate and equidistant from its side edges or coinciding with the longitudinal axis of the plate, in the both directions for an identical angle from the position, at which the curved lateral parts of the plate pointed up and forward in the direction of the bait movement are positioned symmetrically relative to the body, and the body is made of a material having density more than density of water.

The object is also achieved with an artificial bait of wobbler type for amateur fishing, which comprises a body having its centre of gravity located at its forward portion with at least one hole for fixing a fishing line and with at least one hole for fixing at least one hook, ith a plate attached to the body at an angle to the same, wherein, according to the invention, the holes for fixing the fishing line are performed at the upper portion of the body over the spoon-bait center of gravity or with displacement to the nose portion of the body, the plate having the lateral parts symmetrically curved convex relative to its longitudinal axis of symmetry is movably attached, by means of a motionless holder, to the nose portion or to the lower portion of the body with fixed arrangement of its longitudinal axis at angle of 90° and more but less 180° to the body longitudinal axis, with possibility of the plate rotation round the axis passing through the points of the plate attachment to the holder, parallel to the longitudinal axis of the plate and equidistant from its side edges or coinciding with the longitudinal axis of the plate, to the both directions for an identical angle from the position, at which the curved lateral parts of the plate pointed down and forward in the direction of the bait movement are positioned symmetrically relative to the body, and the body is made of a material having density more than density of water.

In both embodiments of the invention the body can be made of metal and is of an assembled, all-cast or flat, three-dimensional or combined design.

The holder can be executed as an element of the body or connected to the body and manufactured separately in the form of an axle, a rod, or a bent rod, a frame, a clamp, or support, with holes, projections or legs, with holes for movable connection of the plate, or ith the projections restricting the angle of the plate rotation and making impossible its detachment from the holder.

The plate can be manufactured as a lengthened piece with the expanded front or rear portion, of round, triangular, square, rectangular, oval or combined forms etc.

The plate can be performed with its lateral parts symmetrically curved relative to the longitudinal axis and the flat middle part or the lateral parts symmetrically completely curved relative to the longitudinal axis with the different shapes of curving, angle, radius, curvature degree; and curving can be executed of the cylinder, conic, spherical, cut shape, or be of combined forms, etc., or with variable radius of curvature, or also the plate can have curved front or rear portions.

Along the longitudinal axis, the plate can be provided with some holes or a special longitudinal hole, or projections or legs with holes, or a sleeve for its junction w ith the holder, or an axle for movable attachment to the holder.

The artificial bait may contain weight attached movable or rigidly fixed at front portion of the body by one or two hinges.

The filed artificial bait combines compactness and weight being essential for its size. It is equipped with a small plate, characterized by great throwing distance, which in the course of uniform slow leading creates intensive oscillations with wide structurally provided range of frequencies and amplitudes of oscillations, and it can fluctuate both at uniform movement, and also at free immersing onto the bottom. Besides, at uniform movement, the bait is capable to move at the preliminary specified horizon of leading without emersion being inherent for the most art examples of the artificial baits for spin fishing.

The bait independently and quickly deepens to a low depth directly at the place of throwing and it passes all the distance at the specified effective depth. The bait can operate not only at leading, but also after stopping. This feature provides a possibility of its application at jig method comprising phases of lifting and free lowering of the bait. Thus, it is known that attacks of a predator are more frequent while the phase of lowering the bait, which continues fluctuating.

In comparison with the prototype, being provided with a compact body of raised weight and a small plate, the bait has the best flight characteristics and is suitable for long-distance throwing.

The filed bait is universal at application, in particular, for deep fishing at considerable depths by the uniform leading fishing technique as well as the jig method. It independently deepens onto a bottom at the place of throwing and, at the subsequent uniform movement, keeps the horizon having been specified by a fisher for leading at the bottom under condition of carrying out stable and intensive oscillations at the most minimum speed of movement.

Besides, the bait can be effectively applied for fishing with the use of trolling technique as the same model can be used for leading at various operating depths, since even little changes of a boat movement speed and a length resulted from weakening a cord can provide considerable change for spoon-bait leading operating depth.

The same properties allow using a spoon-bait for trolling directly at the bottom with a complex topography, and also at considerable differences of depths. Thus, unlike wobblers, which usually increase a deepening depth at increasing a boat movement speed, the bait under the invention increases the deepening depth at reducing the above said speed: and this fact does not affect its attraction for a predator preferring moderate speed of a catch movement.

The bait also has a design possibility to manufacture models moving directly at the surface of water while conducting a uniform low speed leading technique of Fishing.

The bait design provides an opportunity for a wide range mass production of low cost as a result of possibility to apply inexpensive materials, universal set of completing elements, manufacture at standard equipment, without using expensive materials and technologies. There is occurred a possibility to produce the models having a wide range of frequencies and amplitudes of oscillations using the same component parts and at one and the same equipment.

The invention is further explained by the following embodiments.

### BRIEF DESCRIPTION OF THE DRAWINGS

FIG. 1 is a first embodiment of the artificial bait for amateur fishing with the plate located at an acute angle to the longitudinal axis of the body, the general view;

FIG. 2 is a second embodiment of the artificial bait for amateur fishing with the plate located at an obtuse angle to the longitudinal axis of the body, the general view:

FIG. 3 is a plate with a holder in the form of a bent rod, freely passed through the plate holes;

FIG. 4 is a plate with a holder in the form of a support with projections freely passed through the plate holes;

FIG. 5, FIG. 6, FIG. 7 are the plates with ith the holders in the form of an axle:

FIG. 8 is a frontal view of the plate for the baits intended for deep fishing:

FIG. 9. FIG. 10, are the frontal views of the plate for the bait intended for deep fishing, at the pate deflection in varies directions:

FIG. 11-FIG. 16 are the variants of the plate configuration;

FIG. 17 is a variant of the bait with the holder executed as an element of the body with the clamp.

### DETAILED DESCRIPTION AND PREFERRED EMBODIMENTS OF THE INVENTION

The artificial bait for amateur fishing contains body 1, wherein in front portion of the body there is motionlessly or movably installed weight 2 with the help of one or two hinges.

Body 1 can be made of metal. The body can be manufactured assembled or integrally cast, flat, three-dimensional or combined, or it can have additional curved, flat or combined longitudinal surfaces, or a three-dimensional body in a section can have expansion in its upper portion. Body 1 is made of a material which density is more than the density of water.

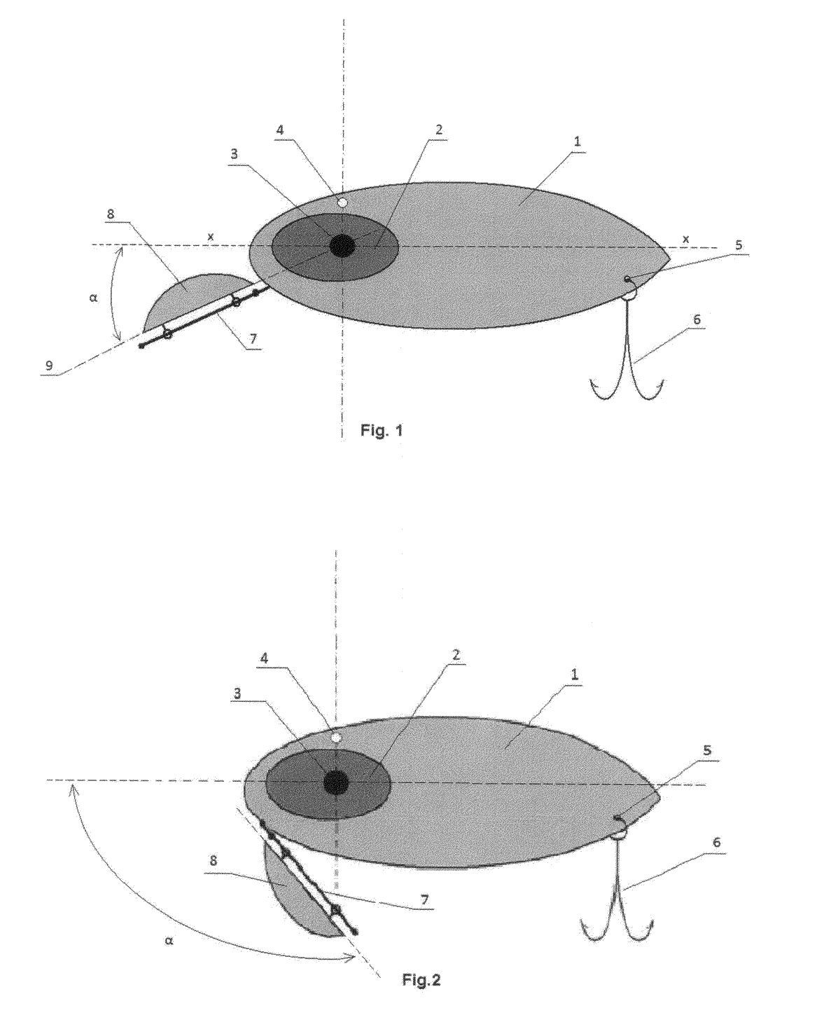

At the front portion of body 1 there is its centre of gravity 3. Body 1 has, at least, one hole 4 for fixing a fishing line (see FIG. 1 and FIG. 2). The hole(s) is (are) executed at the upper portion of body 1 over centre of gravity 3 of the spoon-bait and, at least, one hole 5 for fixing, at least, one hook 6.

To the nose portion or to the lower portion of body 1, by means of motionless holder 7, there is movably attached plate 8 having symmetrically curved relative to its longitudinal axis 9 of symmetry lateral parts 10, 11 with fixed arrangement of its longitudinal axis 9 at angle α to spoon-bait body 1 longitudinal axis, which is more 0° but less 90° for the fist variant of the bait after the invention (see FIG. 1), or at angle 90° and more but less 180° for the second variant of the bait after the invention (see FIG. 2). Plate 8 is performed with a possibility of its rotation round the axis passing through the points of plate 8 attachment to holder 7, parallel to longitudinal axis 9 of plate 8 and equidistant from its side edges or coinciding with longitudinal axis 9 of plate 8, in the both directions for an identical angle from the position, at which curved lateral parts 10, 11 of the plate pointed for the baits under angle α less 90° up and forward in the direction of the bait movement, and for the baits under angle α more 90° down and forward in the direction of the bait movement are positioned symmetrically relative to body 1.

Arranging plate 8 at an acute angle (FIG. 1) is applied at deep fishing, and arranging plate 8 at an obtuse angle (FIG. 2) is applied at surface fishing and also at the use of the heavy body with the small plate at fishing by jig method.

Plate 8 can be manufactured as a lengthened piece with the expanded front or rear portion, or of round, triangular, square, rectangular, oval or combined forms, etc.

Plate can be performed with its lateral parts 10, 11 symmetrically curved relative to longitudinal axis 9 and the flat middle part or lateral parts 10, 11 completely symmetrically curved relative to the longitudinal axis with different shapes of curving, angle, radius, and curvature degree. Curving can be executed of the cylinder, conic, spherical, cut shape, or he of combined forms, etc. or curving can have variable radius of curvature, or also the plate can have curved front or rear portions.

Along longitudinal axis 9, plate 8 can be provided with some holes or a special longitudinal hole, or projections or legs with holes, or a sleeve for its junction with the holder, or an axle for movable attachment to the holder.

Plate 8 can be made of metal or plastics.

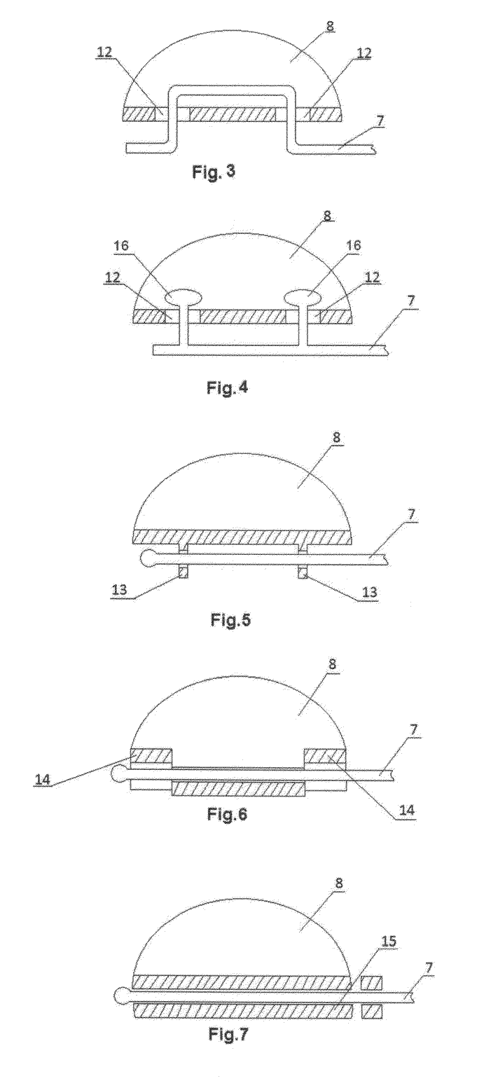

Holder 7 can be executed as an element of the body (FIG. 7) or connected to body 1 and manufactured separately in the form of a bent rod, which passes through holes 12 of plate 8 (FIG. 3), the axle that is located in legs 13 (FIG. 5), the axle passed through the holes in projections 14 of plate 8 (FIG. 6). the axle located into sleeve 15 (FIG. 7), the support with projections 16 passing through holes 12 of plate 8 (FIG. 4).

In the tail portion of body 1 there would he fixed a small tassel or a soft tail made of fur or synthetic and polymeric material, connected to a hook or executed separately (not shown).

As executed for a bottom leading, the artificial bait functions as follows.

Having been thrown, the bottom bait of compact size, considerable weight and having small plate 8 located at angle α to the longitudinal axis of the bait independently sinks onto the bottom at a speed of conventional sinking baits. After the bait has deepened onto the bottom and started leading, its body 1 takes horizontal or near horizontal position, wherein plate 8 is occurred beveled down and arranged with its side having projecting lateral parts 10, 11 being faced toward the incoming flow of water at acute angle α to it.

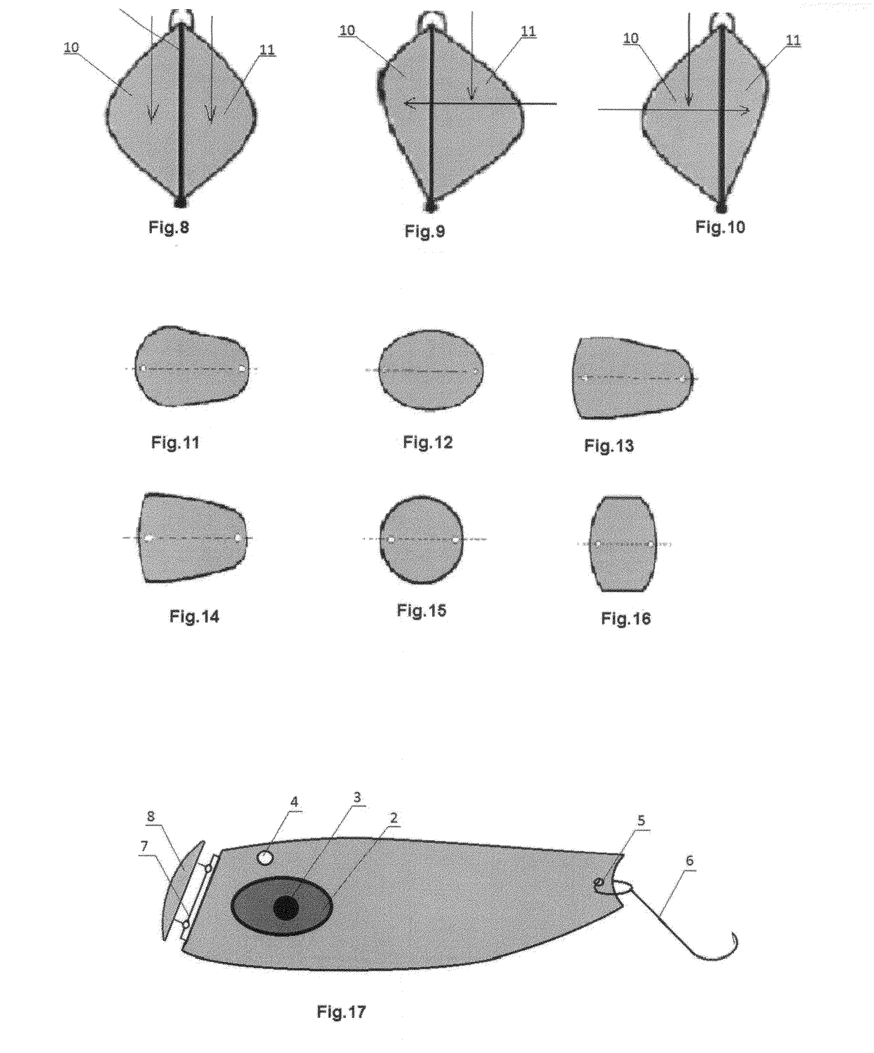

At the beginning of movement, plate 8 is at its middle position, and its surface with curved convex lateral parts 10, 11 and, accordingly, with its concave middle part, under the influence of turbulence forces, turns round the axis, which passes through the points for fixing plate 8 to holder 7, and which is parallel to longitudinal axis 9 of plate 8 and equidistant from its lateral edges or coinciding with longitudinal axis 9 of the plate. Thus, under the action of the incoming flow of water onto the operating surface of plate 8, the last turns, and as the axis, which it turns around, is arranged at a constant angle to the incoming flow of water in vertical plane, the lowered down portion of curved convex plate 8 occupies position at which the tilted surface of lateral part 10 or 11 of the plate is inclined downwards and occurred angled to the incoming flow of water in vertical plane, and the surface of lateral part 11 or 10 of the plate, which is lifted upwards, inclines aside (FIG. 8, FIG. 9, FIG. 10). At this moment, as a result of water flow pressure action upon the plane of plate 8 being lowered and inclined downwards, there is occurred vertical force directed downwards and pressing plate 8, and accordingly, bait body 1 connected with the plate by means of the holder and moving downwards to a bottom. Thus, operating together with the bait gravity, this force counterbalances the buoyancy directed upwards and resulted from a fishing line resisting force and head resistance of the bait itself. Under such a condition, not surfacing, the bait continues to move in a horizontal plane. Simultaneously, onto the surface of plate 8 lifted upwards and inclined aside, there acts the horizontal lateral force directed perpendicularly to the movement direction. This force deflects plate 8, and accordingly, body 1 of the bait attached to it in the direction, wherein there is lifted upwards lateral part 10 or 11 of plate 8. Accordingly, plate 8 and body 1, to which it is attached by means of the holder operating in this case as a lever, deviate aside. Following plate 8, while turning body 1, onto the body lateral surface occupying position at an angle to the direction of motion, there influences the lateral force applied in the direction opposite to the lateral force applied onto plate 8. This force increases in the course of body 1 rotation, at some moment both forces are balanced, and body 1 rotation stops. At this moment, plate 8, turned into its extreme position, as a result of the turbulence forces, starts moving in the opposite direction, with lowered lateral part 11 or 10 of the plate turning up and occurring tilted in one direction, and lateral part 10 or 11, which in the previous phase was deflected upward, starting to lower into position wherein it is tilted down. At some moment, plate 8 passes the intermediate position, wherein both lateral parts 10, 11 of the plate are equally deflected downwards and aside and are symmetric relative to the body of the bait, respectively, in this position, the force directed vertically downward is equally applied onto both lateral parts 10, 11 of the plate. At the subsequent rotation of plate 8, to its lateral lowering part 10, there is applied the force, which is directed vertically downwards and presses the bait in the downward direction. Onto lateral rising part 11 of the plate, there is also applied the lateral force deflecting body 1 of the bait in the direction opposite to the lateral force applied at the previous phase. Owing to the horizontal force alternately applied to the nose part of the bait in one and other direction, the bait performs rhythmical and active oscillations of body 1. Thus, the holder being motionless relative to the bait body, while transferring vertical and sign-variable horizontal forces applied onto the plate, operates as a lever.

Depending on the structurally set angle of plate 8 deflection and the form of its curvature, the surface of lateral part 10 of the plate lowered at rotation into extreme position can slope downwards, but have no skew aside. In this case, only the force vertically directed downwards is applied onto plate 8. There might be a situation, wherein plate 8, having passed a position, at which its lowered lateral part 10 has been inclined only downwards, and this lateral part of plate 8 continues to slope and at a moment it appears inclined not only downwards, but also aside, such a lateral part of plate 8, except pressing the bait to the bottom, also takes part in deflecting body 1 of the bait aside, as the lateral force applied to the said lateral part is pointed there into the same direction, as the force applied to lifted lateral part 11.

This process continuously repeats in the course of the bait movement and therefore the bait carries out continuous oscillations from one side to another, and at certain depth its movement is provided not only at the expense of the body weight, but also at the expense of the force vertically directed downwards and applied to plate 8. As a result, the intensive, steady and uniform oscillations of the bait are provided at the slowest leading of this bait, up to the moment of its full stop.

The combination of the design features of plate 8 having curved lateral parts 10, 11, with the possibility of plate 8 irrespective of body 1 to rotate in both directions for an identical angle round the axis which is passing through the points of its attachment to the holder, parallel to the longitudinal axis of the plate, equidistant from its edges or coinciding with the longitudinal axis of the plate, provides for the occurrence of much more intensive variable opposite lateral forces which are applied to the nose portion of the plate, in comparison with the prototype, since the rotation of plate 8 and arrangement of its lateral parts 10, 11 at a side angle to a flow of water in one and other direction does not require overcoming inertia of body 1 mass as a whole and forces of its resistance to the flow of water, therefore the bait design provides the active oscillations of heavy body 1 of the bait even executed integrally cast of metal. In addition, such a design with a smaller plate, than in the prototype, provides for the creation of the intensive oscillations of the bait even at the minimum speed of leading, and it also provides for the creation of the oscillations at the bait free lowering onto a bottom.

In addition, at constructively increasing angle α, which longitudinal axis 9 of plate 8 may he inclined at, there could be manufactured the models oscillating not only at uniform leading technique of fishingFIG. but also at free sinking to the bottom that makes it possible to use such baits for the jig fishing techniqueFIG. wherein the bait rises from the bottom and then performs free lowering to the bottom. AccordinglyFIG. plate 8 in such bait is less inclined down and at bait moving, the deepening force is reduced.

The artificial bait performed for fishing in top layers of water functions as follows.

Plate 8, being in the middle position, is turned downwards with the side having curved lateral parts 10, 11, thus the rear portion of plate 8 of the moving bait is lowered relative to its front portion therefore the counter water flow washes that side of plate 8. which has curved lateral parts 10, 11. Thus, the surface of plate 8 is oriented within incoming flow of water like a wing of a plane or a speedboat wing. As a result, to both lateral parts 10, 11 of plate 8, there is applied the vertical force, which is directed upwards, counterbalances the bait gravity and prevents the bait from lowering downwards. In this position, the lateral forces are equal, directed to opposite sides and counterbalance each other.

At rotation of plate 8 under the influence of the turbulence forces, one of its lateral parts 10 or 11 turns upwards and its surface continues to create the elevating force. It provides for the movement of the bait that is similar to the movement of a speedboat, directly at the surface. Accordingly, opposite lateral part 11 or 10 of plate 8 lowers downwards and slopes aside, and onto the same, there is applied the lateral force declining body 1 aside. Depending on plate 8 angle of rotation and the form of its curving, the rising lateral part 10 or 11 of plate 8 can be brought into position wherein it is only lifted upwards, and at its further raising this part 10 or 11 of plate 8 appears inclined aside too, accordingly, there is occurred the additional lateral force pointed in the same direction, as the lateral force applied to the lowered lateral part of plate 8.

Plate 8 rotation results in steady and uniform oscillations of body 1 of the bait, just as in the bait wherein the plate participates in deepening. At applying heavy body 1 in combination with small plate 8, there is a probability to use such a model for jig fishing method wherein the bait constantly rises from a bottom and freely deepens onto it continuing to fluctuate. Thus, at free lowering the bait, plate 8 would provide for oscillations and make slow down the process of lowering the bait thereby prolonging the operating phase of fishing.

The design of the bait both for deep fishing and for fishing in water surface layers allows creating baits with a wide range of oscillations that is of the high-frequency oscillations with small amplitude to the uniform wide oscillations with small frequency.

The character of oscillations depends, first of all, on the form of curving lateral parts 10, 11 of plate 8. So, smoothly curved plate 8 with small degree of bending provides trembling, but soft enough oscillations of high frequency, thus the amplitude of the oscillations of body 1 is small. At applying plate 8 with considerable degree of bending, its lateral parts 10, 11 oscillation frequency decreases, but body 1 swinging amplitude increases.

One more parameter influencing the character of playing the bait is holder 7 design. Increasing holder 7 projection in forward direction provides for increasing the oscillations frequencies at small amplitudes, applying holder 7 with a considerable projection directed downwards promotes increasing the amplitude.

Using plate 8 of rounded form of curving (convex) provides creation of soft oscillations, faceted (cut) plates and plates with flat surfaces provide a sharper vibrating play of the bait.

Of great importance is angle a between the longitudinal axis of the plate and the longitudinal axis of the spoon-bait body 1. So, in general, the closer to 90 degrees angle α between the longitudinal axis of the plate 8 and the longitudinal axis of the spoon-bait body 1, the more vigorous and sweeping oscillations the bait produces. The above said parameter in the same way influences on the provision of the bait oscillations when it is free sinking to the bottom. At the moment when the bait is performing the uniform movement, the plate effect of deepening or pushing out, respectively, decreases on angle α approaching to 90 degrees. In addition, for the spoon-baits with angle α of more than 90 degrees, increasing angle α results in corresponding lowering the oscillations frequencies and amplitudes; and this fact can be used to catch a predator that prefers non-actively vibrating baits.

The use of plates with varying degrees of curvature of the front and rear portion also helps to increase the amplitude of oscillations, with the best result of using a plate with a flattened front portion and having a substantially greater degree of bending of the rear portion.

In addition, the spoon- bait operation depends on plate 8 deflection angle in both directions from the middle position, wherein curved lateral parts 10, 11 of plate 8 are symmetrical with respect to body 1. For example, increasing the angle of plates 8 deflection results in an increase of the spoon-bait amplitude in motion. Constructively specified angle of plate 8 rotation can be regulated with limiting devices used in the case of applying holder 7 manufactured in the form of axle, which rotates plate 8 that put on it through sleeve 15, or the holes in legs 13, or the holes in projections 14 of plate 8, and in the cases where plate 8, which has holes in its surface, is connected to holder 7, having a corresponding curving (cambers) or projections that are threaded into holes 12 of plate 8 (FIG. 3, FIG. 4), plate 8, angle can be increased by increasing the gap between the projections or curved portions of holder 7 and holes 12 of plate 8, which (the gap) provides flexible connection of plate 8 with holder 7.

For fishing at great depths, including trolling, it is advisable to use plate 8, located at the low and front portion of body 1 of the spoon-bait, so that plate 8 or its portion would occur under the center of gravity 3 of the spoon-bait both 1.

There is occurred a significant influence of a choice of position 4 for fixing the fishing line to the upper edge of body I on the operation of the bait. Thus, the location of the fishing line attachment directly over the center of gravity of the bait or with a slight shift in its tail portion direction ensures its reliable operation at the lowest speed. When moving in a stream of water, the nose portion of the bait is deepening considerably inclined. This fact reduces the likelihood of catching on the bait equipped with hook 6 in the lower, middle and tail portions.

At free deepening onto the bottom, such a variant of attachment provides the bait body 1 oscillations with high frequencies and low amplitudes at the lowest possible speed of the bait motion. With this method of fishing line fixing, the bait should be used for the uniform slow leading.

At replacing the position of the fishing line attachment to the nose portion of the bait, there increases the amplitude at the large frequency of oscillations, but also increases the speed at which the bait could operate most effectively. In this case, at the moment of leading stop and in the course of tree deepening to the bottom, the fishing line is attached to the bait in such a way that there are created oscillations and vibrations, which allow using the bait for jig fishing method, since the speed of leading bait at the phase of lifting from the bottom is not of significant importance for this method of fishing.

Certain value for a good flight of the bait at throwing as well as for activity of its oscillations is the location of center of gravity 3 of the spoon-bait body 1, and mass separation of body 1 from the center of gravity 3 of the spoon-bait body. Thus, for the good flight of spoon-bait at the moment of throwing, the best results are showed by the spoon-baits with a center of gravity 3 shifted forward, wherein the mass of body 1 is substantially separated (spaced) along the spoon-bait by applying an elongated weight 2 with relative worsening its front portion, or by applying all-cast body 1 of similar shape. It is also advisable to shift the spoon-bait center of gravity 3 to the upper edge of the spoon-bait body.

1. An artificial bait of wobblier type for amateur fishing, comprising
a body having its centre of gravity located at its front portion with at least one hole for fixing a fishing line and with at least one hole for fixing at least one hook, with a plate attached to the bait body at an angle, wherein
the at least one hole for fixing the fishing line are performed at an upper portion of the body over a bait center of gravity or with displacement to a bait nose portion.
the plate having lateral parts symmetrically curved convex relative to a plate longitudinal axis of symmetry is movably attached by means of a motionless holder to the nose portion of the body with fixed arrangement of the plate longitudinal axis at angle more 0° but less 180° to the body longitudinal axis, with possibility of the plate rotation round an axis passing through points of the plate attachment to the motionless holder, coinciding with the longitudinal axis of the plate or parallel to the longitudinal axis of the plate and equidistant from the plate side edges, in the both directions for an identical angle from a position, at which the curved lateral parts of the plate pointed with a slope and forward in a direction of the bait movement are positioned symmetrically relative to the body, and
the body is made of a material having density more than density of water.

2. The artificial bait as claimed in claim 1, wherein the body is made of metal and is selected from the group consisting of an assembled, all-cast, flat, three-dimensional or combined design.

3. The artificial bait as claimed in claim 1, wherein the holder is executed as an element of the body with a component part selected from the group consisting of a clamp, legs ith holes, projections for movable attachment of the plate, cambers, stops (catches) restricting the angle of the plate rotation and making impossible its detachment from the holder, and of additional holes.

4. The artificial bait as claimed in claim 1, wherein the holder manufactured separately in the form selected from the group consisting of an axle, a rod, a bent rod, a frame, a clamp, a support with holes, projections or legs [symbol] holes for movable attachment of the plate, projections, cambers, stops (catches) restricting the angle of the plate rotation and making impossible its detachment from the holder, and of additional holes.

5. The artificial bait as claimed in claim 1, wherein the plate is manufactured selected from the group consisting of a lengthened piece with an expanded front or rear portion, a piece of a round, triangular, square, rectangular, oval and combined form.

6. The artificial bait as claimed in claim 1, wherein the plate has the lateral parts symmetrically curved convex relative to the longitudinal axis and the flat middle part or the lateral parts symmetrically completely curved relative to the longitudinal axis with the different shapes of curving, angle, radius, curvature degree, and wherein curving is executed in form selected from the group consisting of the cylinder, conic, spherical, cut shape, and combined form with variable, degree of curvature, and the plate has curved front or rear portions.

7. The artificial bait as claimed in claim 1, wherein in the plate along its longitudinal axis being provided with elements selected from the group consisting of two holes spaced to the edges of the plate, a special longitudinal hole, projections, legs with holes, a sleeve, which are intended for joining the plate with the holder, or an axle for movable attaching the plate to the holder.

8. The artificial bait as claimed in claim 1, additionally comprising a weight attached movable or rigidly fixed at front portion of the body at least one hinge.

9. An artificial bait of wobblier type for amateur fishing, comprising
a body having its centre of gravity located at its front portion with at least one hole for fixing a fishing line and with at least one hole for fixing at least one hook, with a plate attached to the bait body at an angle, wherein the at least one hole for fixing the fishing line are performed at an upper portion of the body over the bait center of gravity or with displacement to a bait nose portion, the plate having lateral parts symmetrically curved convex relative to a plate longitudinal axis of symmetry is movably attached by means of a motionless holder to a lower portion of the body with fixed arrangement of the plate longitudinal axis at angle more 0° but less 180° to the body longitudinal axis, with possibility of the plate rotation round an axis passing through points of the plate attachment to the motionless holder, coinciding with the longitudinal axis of the plate or parallel to the longitudinal axis of the plate and equidistant from the plate side edges, in the both directions for an identical angle from a position, at which the curved lateral parts of the plate pointed with a slope and forward in a direction of the bait movement are positioned symmetrically relative to the body. and
the body is made of a material having density more than density of water.

10. The artificial bait as claimed in claim 9. wherein the body is made of metal and is selected from the group consisting of an assembled, all-cast, flat, three-dimensional and combined design.

11. The artificial bait as claimed in claim 9, wherein the holder is executed as an element of the body with a component part selected from the group consisting of a clamp, legs with holes, projections for movable attachment of the plate, cambers, stops (catches) restricting the angle of the plate rotation and making impossible its detachment from the holder, and of additional holes

12. The artificial bait as claimed in claim 9, wherein the holder manufactured separately in the form selected from the group consisting of an axle, a rod, a bent rod, a frame, a clamp, support with holes, projections or legs [symbol] for movable attachment of the plate, projections, cambers, stops (catches) restricting the angle of the plate rotation and making impossible its detachment from the holder, and of additional holes.

13. The artificial bait as claimed in claim 9, wherein the plate is manufactured selected from the group consisting of a lengthened piece with an expanded front or rear portion, a piece of a round, triangular, square, rectangular, oval and combined form.

14. The artificial bait as claimed in claim 9, wherein the plate has the lateral parts symmetrically curved convex relative to the longitudinal axis and the flat middle part or the lateral parts symmetrically completely curved relative to the longitudinal axis with the different shapes of curving, angle, radius, curvature degree, and wherein curving is executed in form selected from the group consisting of the cylinder, conic, spherical, cut shape, and combined form with variable degree of curvature, and the plate has curved front or rear portions.

15. The artificial bait as claimed in claim 9, wherein in the plate along its longitudinal axis being provided with elements selected from the group consisting of two holes spaced to the edges of the plate, a special longitudinal hole, projections, legs with holes, a sleeve, which are intended for joining the plate with the holder, or an axle for movable attaching the plate to the holder.

16. The artificial bait as claimed in claim 9, additionally comprising a weight attached movable or rigidly fixed at front portion of the body by at least one hinge.
